(19) United States
(12) Patent Application Publication
(10) Pub. No.: US 2008/0098544 A1
(43) Pub. Date: May 1, 2008

(54) Drain cleaning machine with added stability, portability and maneuverability

(75) Inventors: Michael J. Rutkowski, Brunswick, OH (US); Jon R. Dunkin, Elyria, OH (US); Larry F. Babb, Grafton, OH (US)

Correspondence Address: RANKIN, HILL & CLARK LLP, 38210 Glenn Avenue, WILLOUGHBY, OH, 44094-7808, US

(73) Assignee: Emerson Electric Co.

(21) Appl. No.: 11/589,545

(22) Filed: Oct. 30, 2006

(51) Int. Cl. B08B 9/02

(52) U.S. Cl. 15/104.33

(57) ABSTRACT

A drain cleaning apparatus includes a frame member, a rotatable cable storage drum, a drain cleaning cable, and a motor. The frame member is configured to rest on an associated surface. A wheel, or other friction reducing device, can connect to the frame member to facilitate moving the drain cleaning apparatus across the associated surface. The rotatable cable storage drum mounts to the frame member. The drum defines an axis. The drum includes axially spaced front and rear ends and a radial outer peripheral wall between the front and rear ends. The front end of the drum includes an opening. The drain cleaning cable is coiled in the drum about the axis. The cable includes an outer end portion extending through the opening. The motor includes an output shaft and a motor housing. The output shaft of the motor is operatively connected with the drum for rotating the drum relative to the frame.

### BACKGROUND

Machines used to clean drain pipes typically include a drum having a cable, or snake, coiled within the drum. The drum is rotated by an endless belt trained about a motor driven pulley and the outer periphery of the drum or a drum mounted pulley. These machines can be very heavy and difficult to move; however, these machines still need to be moved to a location near the drain that needs to be cleaned.

Wheels can be provided with these drain cleaning machines so that they are portable. The addition of wheels to such a drain cleaning machine, however, can reduce its stability and also increase the overall size or footprint of the machine. Handles can be added to assist moving the machine, but overall size (height) then becomes an issue for storage. Moreover, the addition of wheels and handles to the drain cleaning machine does not mitigate the difficulty of traversing staircases.

### BRIEF DESCRIPTION

A drain cleaning apparatus includes a frame member, a rotatable cable storage drum, a drain cleaning cable, and a motor. The frame member is configured to rest on an associated surface. A wheel, or other friction reducing device, can connect to the frame member to facilitate moving the drain cleaning apparatus across the associated surface. The rotatable cable storage drum mounts to the frame member. The drum defines an axis. The drum includes axially spaced front and rear ends and a radial outer peripheral wall between the front and rear ends. The front end of the drum includes an opening. The drain cleaning cable is coiled in the drum about the axis. The cable includes an outer end portion extending through the opening. The motor includes an output shaft and a motor housing. The output shaft of the motor is operatively connected with the drum for rotating the drum relative to the frame.

The drain cleaning apparatus discussed above can include a stair climber skid on the frame member. The stair climber skid can include a skid surface configured to slidably engage an associated stair when the apparatus is being moved up or down a staircase that includes the associated stair.

The drain cleaning apparatus discussed above can also include a movable member connected to the frame member and selectively movable between a first position and a second position. The movable member includes a handle portion configured for gripping when the movable member is in the first position. The movable member also includes a surface engaging portion configured to contact the associated surface when the movable member is in the second position. Moving the movable member into the second position can provide stability by moving the center of gravity of the machine and also reduce the overall height of the machine for easy storage.

### BRIEF DESCRIPTION OF THE DRAWINGS

FIG. 1 is a front perspective view of a drain cleaning apparatus;

FIG. 2 is an exploded view of a portion of the drain cleaning apparatus depicted in FIG. 1;

FIG. 3 is a rear perspective view of the drain cleaning apparatus depicted in FIG. 1;

FIG. 4 is a side elevational view of the drain cleaning apparatus depicted in FIG. 1;

FIG. 5 is an exploded view of a portion of the drain cleaning apparatus depicted in FIG. 1;

FIG. 6 is a front elevational view of the drain cleaning apparatus depicted in FIG. 1;

FIG. 7 is a rear elevational view of the drain cleaning apparatus depicted in FIG. 1;

FIG. 8 is a top plan view of the drain cleaning apparatus depicted in FIG. 1;

FIG. 9 is a bottom plan view of the drain cleaning apparatus depicted in FIG. 1;

FIG. 10 is an exploded view of an alternative embodiment of a drain cleaning apparatus;

FIG. 11 is a side elevational view of the drain cleaning apparatus of FIG. 10 with its handle in a lowered position; and,

FIG. 12 is a side elevational view of the drain cleaning apparatus of FIG. 10 with its handle in an upright position.

### DETAILED DESCRIPTION

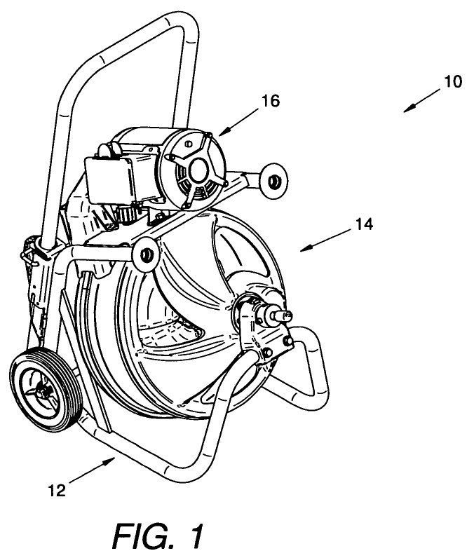

With reference to FIG. 1, a drain cleaning apparatus 10 includes a frame assembly 12, a rotatable drum unit 14 and a drum driving assembly 16. The drain cleaning apparatus depicted in FIG. 1 is very portable and can easily traverse stairs.

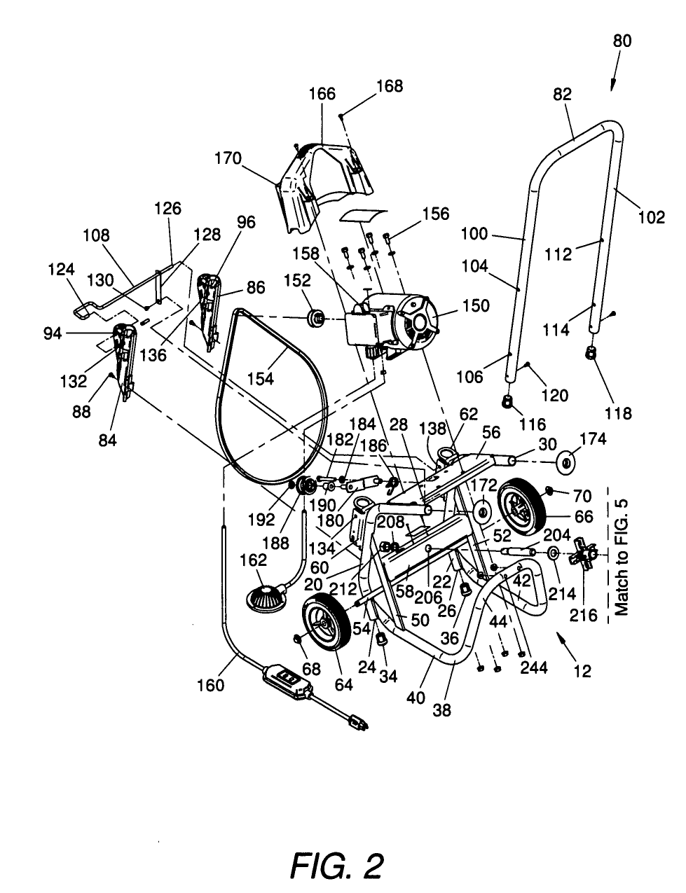

With reference to FIG. 2, the frame assembly 12 generally includes first and second spaced arm members 20 and 22. The arm members are made from tubular metal stock or similar materials and each include first (lower) ends 24 and 26, respectively, and second (upper) ends 28 and 30, respectively. The lower portion of each arm member 20 and 22 includes a bend so that the lower ends 24 and 26, respectively, are located nearer to the drum unit 14. A first foot 34 connects with the first, or lower, ends 24 of the first arm member 20. Similarly, a second foot 36 connects with the first end 26 of the second arm member 22. The feet 34 and 36 are made of rubber, plastic, or similar material.

A U-shaped member 38 attaches to the first arm member 20 near its first end 24 and the second arm member 22 near its first end 26. In the depicted embodiment, the U-shaped member is welded to the arm members 20 and 22. If desired, the U-shaped member 38 and the side arms 20 and 22 can be a single piece of formed metal, or similar material. The U-shaped member 38 generally includes spaced first and second generally horizontal portions 40 and 42. A raised U-shaped interconnecting portion 44 interconnects, and is formed integrally with, the spaced horizontal portions 40 and 42. A first strut 50 interconnects the first horizontal portion 40 of the U-shaped member 38 to the first arm member 20. Similarly, a second strut 52 interconnects the second horizontal portion 42 of the U-shaped member 38 and the second arm member 22.

A motor mount plate 56 interconnects the first arm member 20 to the second arm member 22 near the second, or upper ends 28 and 30 thereof. A drum mounting plate 58 attaches to each of the struts 50 and 52 and extends therebetween. A first bracket 60 attaches to a generally vertical portion of the first arm member 20. A second bracket 62 attaches to a generally vertical portion of the second arm member 22.

Wheels are provided to facilitate moving the drain cleaning apparatus across a surface. A first wheel 64 and a second wheel 66 attach to opposite ends of a wheel axle 54. The wheel axle 54 attaches to the arm members 20 and 22 of the frame assembly. A first cap washer 68 attaches to the axle 54 to attach the first wheel 64 to the axle. A second cap washer 70 attaches to the axle 54 to attach the second wheel 66 to the axle. Alternatively, other types of wheels or friction reducing devices, for example tracks and the like, can be provided to enhance the maneuverability of the drain cleaning apparatus.

A handle 80 connects with the frame assembly 12. In the depicted embodiment, the handle 80 is a U-shaped movable member that is selectively movable between a first position and a second position. When in the first position, a handle grip portion 82 of the movable member is configured for gripping to maneuver the drain cleaning apparatus to its desired location. When in a second position, a portion of the handle 80 contacts the surface on which the apparatus rests to provide more stability to the apparatus 10, which will be described in more detail below. The handle 80, when in the second position, provides added stability to the apparatus 10 by repositioning the center of gravity of the apparatus, as compared to when the handle is in the first position which will also be described in more detail below.

With continued references to FIG. 2, a first handle bracket 84 attaches to the first bracket 60 of the frame assembly 12. Similarly, a second handle bracket 86 attaches to the second bracket 62 of the frame assembly 12. In the depicted embodiment, fasteners 88 are provided to attach the first handle bracket 84 and the second handle bracket 86 to the frame assembly 12; other conventional manners of attachment can be used. Each handle bracket 84 and 86 includes a longitudinal opening 94 and 96, respectively. The longitudinal opening 94 in the first handle bracket 84 receives a first elongated portion 100 of the handle 80. Similarly, the longitudinal opening 96 in the second handle bracket 86 receives a second elongated portion 102 of the handle 80. The elongated portions 100 and 102 are interconnected by (and integral with) the handle grip portion 82 of the handle. The first elongated portion 100 includes an upper opening 104 and a lower opening 106 each configured to receive a portion of a handle release lever 108. The second elongated portion 102 of the handle 80 also includes an upper opening 112 and a lower opening 114 that are also each configured to receive a portion of the handle release lever 108. A first foot 116 connects with a terminal end of the first elongated portion 100. Likewise, a second foot 118 connects with a terminal end of the second elongated portion 102. The feet 116 and 118 are similar to the feet 34 and 36, described above. Fasteners 120 can be provided to facilitate attachment of the feet 116 and 118. The fasteners 120 also preclude removal of the handle from the handle brackets 84 and 86 once the apparatus is finally assembled.

As discussed above, the handle 80 moves with respect to the frame assembly 12. In the depicted embodiment, the handle 80 slides between a first (upright) position where the feet 116 and 118 are not in contact with the surface upon which the frame assembly 12 rests and a second (lowered) position where the feet 116 and 118 are in contact with the surface upon which the frame assembly rests. The handle release lever 108 is selectively received inside the openings 104, 106, 112, and 114 of the handle 80 to hold the handle in either the first position or the second position. When in the first position the handle release lever 108 is received inside the lower openings 106 and 114. When in the second position the handle release lever 108 is received inside the upper openings 104 and 112.

In the depicted embodiment, the handle release lever 108 is a hook-shaped adjacent a first end 124 and is straight adjacent a second end 126. A flat spring 128 includes an opening to receive the handle release lever 108. The flat spring 128 attaches to the second bracket 62 using a fastener 130. The spring 128 biases the handle release lever 108 into the respective openings 104, 106, 112, and 114 of the handle 80. More specifically, the first handle bracket 84 includes an opening 132 that receives the first end 124 of the handle release lever 108 such that the first end of the handle release lever can be selectively received inside the upper opening 104 or the lower opening 106 of the handle 80. An opening 134 is also provided in the first bracket 60 such that when the first handle bracket 84 is attached to the first bracket 60 the openings 132 and 134 align to allow for insertion of the first end 124 of the handle release lever 108. Similarly, the second handle bracket 86 includes an opening 136 and the second bracket 62 includes an opening 138 that aligns with the opening 136 when the second handle bracket 86 is attached to the second bracket 62 such that the openings 136 and 138 can selectively receive second end 126 of the handle release lever 108.

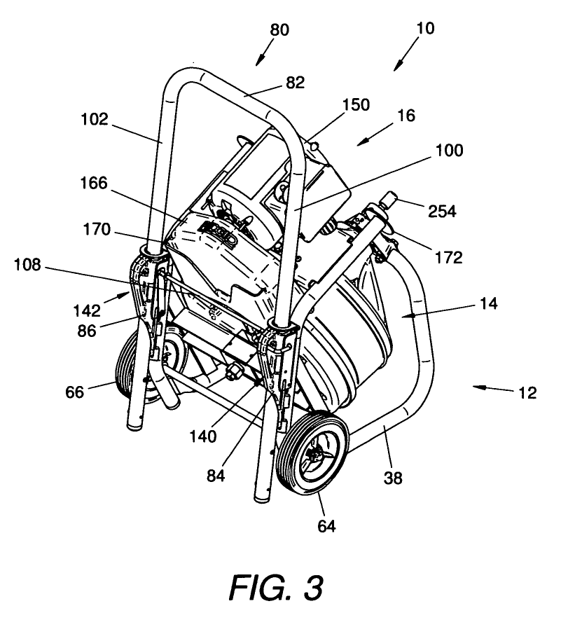

As more clearly visible in FIG. 3, the drain cleaning apparatus 10 also includes skid surfaces to facilitate moving the apparatus up and down a flight of stairs. In the depicted embodiment, the stair climber skids are formed by the handle brackets 84 and 86 that are attached to the frame assembly. Alternatively, the stair climber skids can be formed integrally with the frame, for example, as part of the handle 80 and/or the arm members 20 and 22 of the frame assembly.

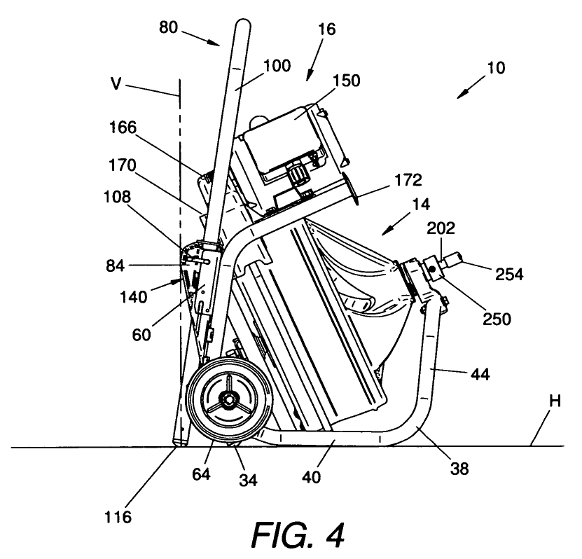

With specific reference to FIG. 3, the first handle bracket 84 defines a first skid surface 140 and the second handle bracket 86 defines a second skid surface 142. In the depicted embodiment, the handle brackets 84 and 86 are identical in configuration. Accordingly, for the sake of brevity, the first handle bracket 84 and its respective skid surface 140 will be described in more detail with reference to FIG. 4.

The handle bracket 84 is a molded plastic (or similar rigid material) piece that tapers from an upper end inwardly towards the first wheel 64. As more clearly seen in FIG. 4, the outermost portion of the first handle bracket 84 and the first skid surface 140 generally defines a vertical plane V (vertical with respect to the ground represented by horizontal plane H). The vertical plane V is disposed outwardly (to the left in FIG. 4) of the drum driving assembly 16. This inhibits the drum driving assembly 16 from contacting a stair of the staircase when the drain cleaning apparatus 10 is being dragged up the staircase (the handle 80 would typically be in its upright position when dragging the apparatus up a staircase). This configuration also provides added stability to the drain cleaning apparatus 10 which will be described in more detail below. The skid surface 140 is displaced from the wheel 64 a distance (measured along an axis in the vertical plane V) such that when the apparatus 10 is dragged near a stair having a conventional height the corner of the stair, i.e., the intersection between the vertical and horizontal portion of the stair, contacts generally the middle of the skid surface 140 to provide a pivot point about which the apparatus is pivoted and then pulled along the skid surface 140.

As seen in FIG. 4, when the handle 80 is disposed in the second (lower) position such that the feet 116 and 118 (second foot not visible in FIG. 4) engage the ground surface, which in FIG. 4 is depicted as the horizontal plane H, the wheel 64 is set off of the horizontal plane. The wheels can always be set off of the ground surface no matter the position of the handle 80, e.g. the apparatus can rest on horizontal portions 40 and 42 when the handle is in the upright position and the wheels can still be offset from the floor. The apparatus 10 rests on the feet 116 and 118, as well as the feet 34 and 36 and a portion of each horizontal portion 40 and 42 of the frame assembly 12. When the handle is moved from the first position into the second position, the center of gravity of the apparatus 10 shifts (to the left in FIG. 4) and the wheels 64 and 66 no longer engage the surface upon which the apparatus 10 rests to provide greater stability to the apparatus when it is in use cleaning a drain. In other words, the center of gravity of the apparatus shifts further away from the distal end (right end in FIG. 4) of the drum unit 14. Additionally, the compact configuration of the drum driving assembly 16 also adds to the stability of the apparatus.

With reference back to FIG. 2, the drum driving assembly 16 includes an electric reversible motor 150 that includes an output shaft (not visible) to which a pulley 152 mounts. The output shaft of the motor 150 extends rearwardly out of the motor housing as opposed to the opening in the drum 14 through which the cable extends, which is forwardly disposed and will be described in more detail below. As most clearly seen in FIG. 3, the motor 150 is positioned above the drum 14 and between the axially spaced front and rear ends of the drum. This provides for a compact apparatus that is easier to maneuver.

The pulley 152 engages an endless belt 154 that wraps around a peripheral wall of the drum 14 to rotate the same. The motor 150 attaches to the motor mount plate 56 via fasteners 156. The motor 150 is an electric reversible motor that includes a switch 158 that can control the direction (forward and reverse) of rotation of the motor. A power cord 160 connects to the motor 150 to provide AC power to the motor. A foot bulb 162 also connects to the motor 150. The foot bulb 162 communicates with a pneumatic switch on the motor so that the operator of the apparatus 10 can step on the foot bulb 162 to selectively supply power to the electric motor 150.

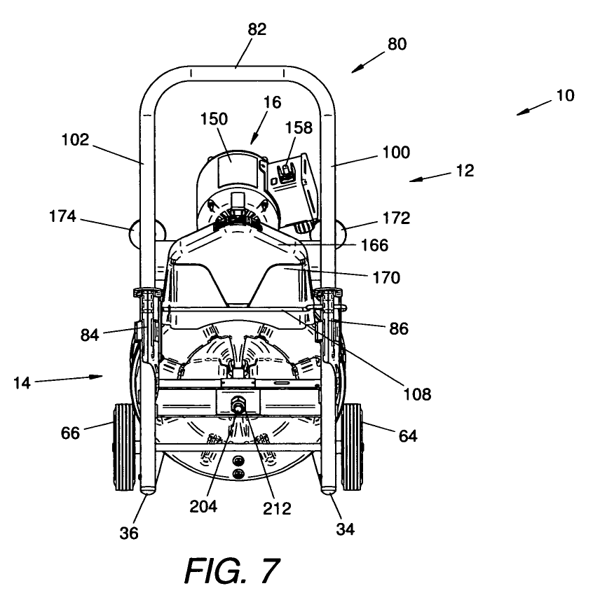

A belt guard, or shroud, 166 attaches to the frame assembly 12 using fasteners 168. The belt guard 166 covers the belt 154 and the pulley 152 to provide protection to these components and also to provide a stationary piece between the operator of the apparatus 10 and the moving components of the apparatus. The belt guard 166 can also include a pocket 170 (see also FIGS. 3 and 7) for the storage of tools and other implements that can be used with the drain cleaning apparatus. The frame assembly 12 can also include cord wrap caps 172 and 174 that attach to the distal ends 28 and 30 of the frame assembly 12. The cord wrap caps 172 and 174 provide a guide about which the power cord 160 and the cord associated with the foot bulb 162 can be wrapped.

A belt tensioning assembly is provided to tension the belt 154. If desired, a stretch belt can be used obviating the need for a belt tensioning assembly. The belt tensioning assembly includes an idler pulley arm 180 that connects to the motor mount plate 56 using a fastener 182 and washer 184. The idler pulley arm 180 includes a bend separating two parallel planar portions. A torsion spring 186 contacts the motor mount plate 56 and the idler pulley arm 180 to bias the idler pulley arm to provide tension to the belt 154. An idler pulley 188 attaches to the idler pulley arm 180 using a flange bearing 190 and a cap washer 192. By providing the belt tensioning assembly, the motor 150 can be fixed with respect to the frame 12.

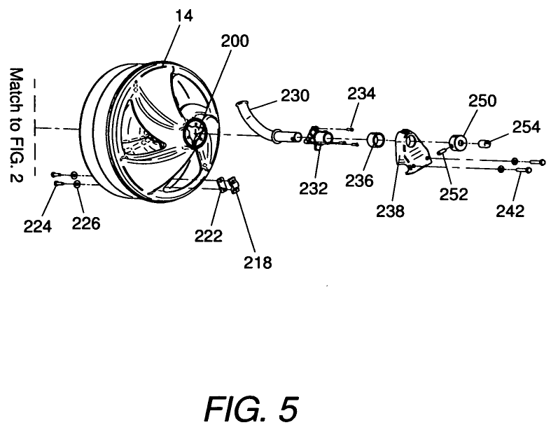

The cable storage drum 14 mounts to the frame 12. The cable storage drum unit 14 defines a rotational axis and includes axially spaced front and rear ends and a radially outer peripheral wall between the front and rear ends. With reference to FIG. 5, the front end of the drum 14 includes an opening 200. A drain cleaning cable 202 (FIG. 4) is coiled in the drum 14 about the rotational axis. The cable 202 includes an outer end portion extending through the opening 200 in a forward direction, which is opposite the direction from which the output shaft of the motor 150 extends from its housing. As can be seen in FIG. 4, the direction that the output shaft extends from the motor 150 is generally parallel to the direction that the cable 202 extends from the drum 14. Positioning the output shaft of the motor 150 so that it extends in a direction opposite the direction that the cable 202 exits the drum 14 provides for a compact and stable apparatus. This facilitates moving the apparatus 10 up and down a flight of stairs.

With reference to FIG. 2, the cable drum 14 rests on a drum support shaft 204 that is received in an opening 206 in a drum mounting plate 58. The drum support shaft 204 connects to the drum mounting plate 58 via a lock washer 208 and a nut 212. A washer 214 is received on the drum support shaft to contact the drum mounting plate 58. A drum support bushing 216 is also received on the drum support shaft 204 and engages the drum 14.

With reference back to FIG. 5, a cable clamp assembly that includes a cable clamp front plate 218 and a cable clamp rear plate 222 attached to one another using fasteners 224 and washers 226. The cable clamp assembly attaches the cable 202 (FIG. 4) inside the drum 14.

A cable guide 230 is received through the opening 200 and then drum 14 and includes a portion that extends from the opening. The cable guide 230 includes an opening through which the cable 202 is fed. A guide tube bearing 232 is received on an outer end of the guide tube 230. The guide tube bearing 232 attaches to the front of the drum using fasteners 234. A sleeve 236 receives guide tube bearing 232. A front bearing housing 238 encloses the guide tube bearing 232 and the sleeve bearing 236. The front bearing housing 238 attaches to the U-shaped portion 38 of the frame assembly 12 (FIG. 2) via fasteners 242 that are received in opening 244 in the frame 12. A set collar 250 attaches to the guide tube 230 using a set screw 252. A cable end cap 254 is supplied on the distal end of the cable as seen in FIG. 4 for shipping the apparatus.

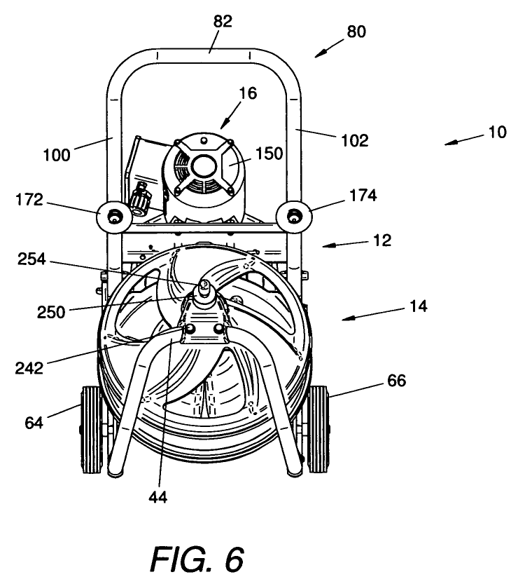

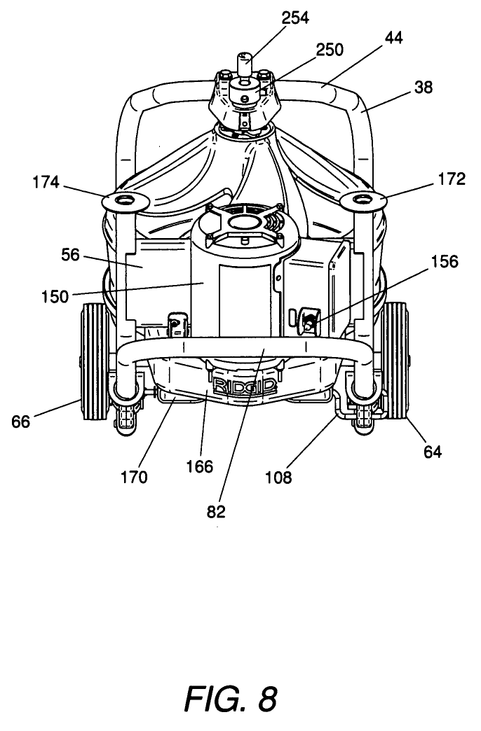

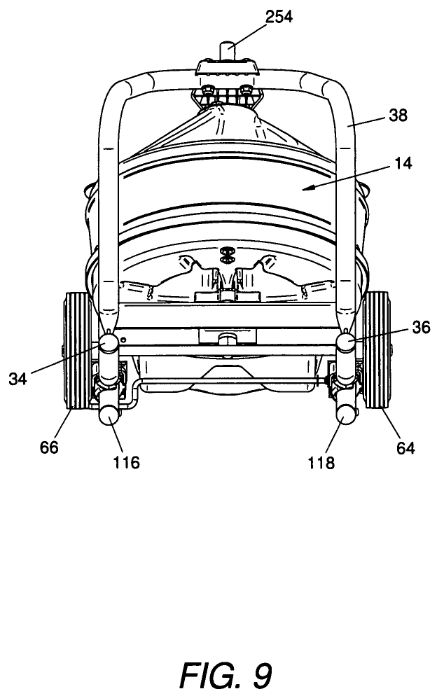

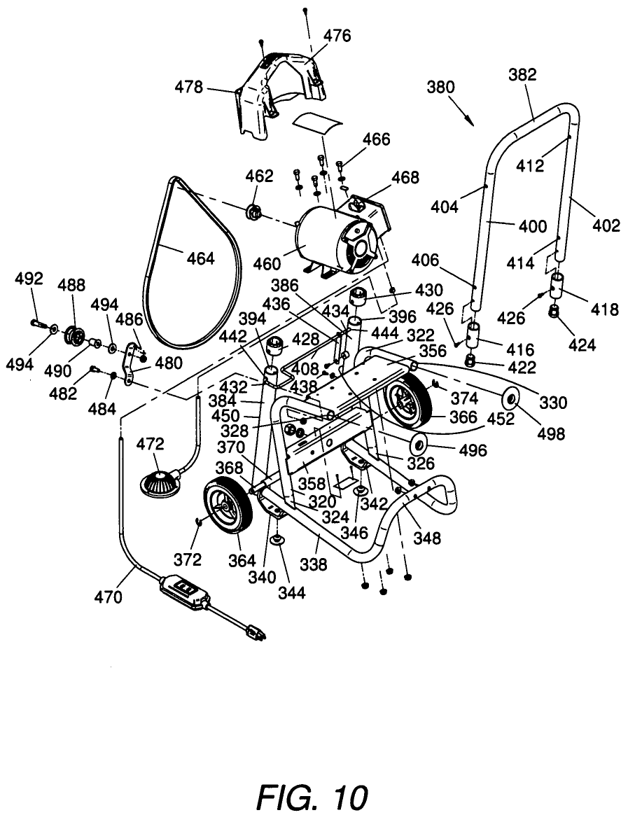

With reference to FIGS. 10-12, an alternative embodiment of a drain cleaning apparatus 310 includes a frame assembly 312, a rotatable drum unit 314 and a drum driving assembly 316. This drain cleaning apparatus depicted in FIGS. 10-12 is also very portable and can easily traverse stairs. Many of the components of this apparatus are very similar, or the same as, the components of the apparatus described with reference to FIGS. 1-9.

The frame assembly 312 generally includes first and second spaced generally L-shaped arm members 320 and 322. The arm members are made from bent tubular metal stock (or similar material) and each include first (lower) ends 324 and 326, respectively, and second (upper) ends 328 and 330, respectively.

A U-shaped member 338 attaches to the first arm member 320 at its first end 324 and the second arm member 322 near its first end 326. In the depicted embodiment, the U-shaped member is welded to the arm members 320 and 322. If desired, the U-shaped member 338 and the side arms 320 and 322 can be a single piece of formed metal, or similar material.

Foot plates 340 and 342, which in the depicted embodiment are formed metal plates, attach to each distal end of the U-shaped member 338. Foot pads 344 and 346, which can be made from rubber, plastic or similar material, attach to the foot plates 340 and 342, respectively.

The U-shaped member 338 includes a raised portion 348 to which the drum unit 314 mounts, which will be described in more detail below. A motor mount plate 356 interconnects the first arm member 320 to the second arm member 322 near the second, or upper ends 328 and 330 thereof. A drum mounting plate 358 also attaches to each of the arms 320 and 322 and extends therebetween.

Wheels are provided to facilitate moving the drain cleaning apparatus across a surface. A first wheel 364 and a second wheel 366 attach to opposite ends of a wheel axle 368. A hollow carrier 370 attaches to the arm members 320 and 322 of the frame assembly. The wheel axle 368 is disposed inside the carrier 370. A first cap washer 372 attaches to the axle 368 to attach the first wheel 364 to the axle. A second cap washer 374 attaches to the axle 368 to attach the second wheel 366 to the axle. Alternatively, other types of wheels or friction reducing devices, for example tracks and the like, can be provided to enhance the maneuverability of the drain cleaning apparatus.

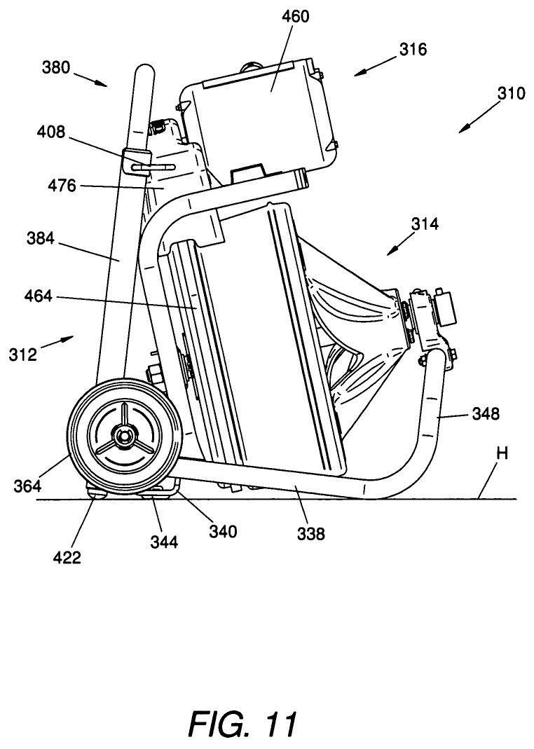

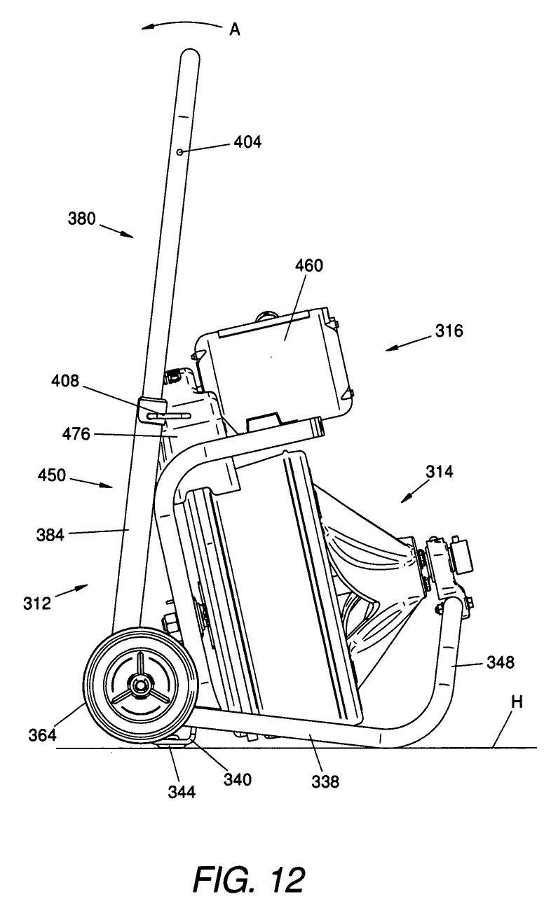

A handle 380 connects with the frame assembly 312. In the depicted embodiment, the handle 380 is a U-shaped movable member that is selectively movable between a first position and a second position. When in the first (upper) position (FIG. 12), a handle grip portion 382 of the movable member is configured for gripping to maneuver the drain cleaning apparatus to its desired location. When in a second (lower) position (FIG. 11), a portion of the handle 380 contacts the surface on which the apparatus rests to provide more stability to the apparatus 310, which will be described in more detail below. The handle 380, when in the second position, provides added stability to the apparatus 310 by repositioning the center of gravity of the apparatus, as compared to when the handle is in the first position which will also be described in more detail below.

A first tubular member 384 attaches to the first arm member 320 and the U-shaped member 348 of the frame assembly 12. Similarly, a second tubular member 386 attaches to the second arm member 322 and the U-shaped member 348 of the frame assembly 12. In the depicted embodiment, the first tubular member 384 and the second tubular member 386 are welded to the frame assembly 312; however, other conventional manners of attachment can be used. Each tubular member 384 and 386 includes a longitudinal opening 394 and 396, respectively. The longitudinal opening 394 in the first tubular member 384 receives a first elongated portion 400 of the handle 380. Similarly, the longitudinal opening 396 in the second tubular member 386 receives a second elongated portion 402 of the handle 380. The elongated portions 400 and 402 are interconnected by (and integral with) the handle grip portion 382 of the handle. The first elongated portion 400 includes an upper opening 404 and a lower opening 406 each configured to receive a portion of a handle release lever 408. The second elongated portion 402 of the handle 380 also includes an upper opening 412 and a lower opening 414 that are also each configured to receive a portion of the handle release lever 408.

A first sleeve bushing 416 connects with a terminal end of the first elongated portion 400. Likewise, a second sleeve bushing 418 connects with another terminal end of the second elongated portion 402. A first foot 422 connects with a terminal end of the first elongated portion 400 and a second foot 424 connects with a terminal end of the second elongated portion 402. The feet 422 and 424 are similar to the feet 34 and 36, described above. Fasteners 426 can be provided to facilitate attachment of the sleeve bushings 416 and 418. Upper sleeve bushings 428 and 430 are also each received in a respective opening 394 and 396 of the tubular members 384, 386 on the frame. The lower sleeve bushings 416 and 418 on the handle 380 contact the upper sleeve bushings 428 and 430 so that when the apparatus is finally assembled the handle 380 is not removed from the tubular member 384 and 386 when the handle 380 is pulled upwardly, as shown in FIG. 12.

As discussed above, the handle 380 moves with respect to the frame assembly 312. In the depicted embodiment, the handle 380 slides between a first (upright) position where the feet 422 and 424 are not in contact with the surface upon which the frame assembly 312 rests and a second (lowered) position where the feet 422 and 424 are in contact with the surface upon which the frame assembly rests. The handle release lever 408 is selectively received inside the openings 404, 406, 412, and 414 of the handle 380 to hold the handle in either the first position or the second position. When in the upright position the handle release lever 408 is received inside the lower openings 406 and 414. When in the lowered position the handle release lever 408 is received inside the upper openings 404 and 412. With specific reference to FIG. 12, the wheels 364 and 366 (only wheel 364 is visible in FIG. 12) are set off of the ground surface H. The handle 380 is moved in the direction of arrow A to engage the wheels.

In the depicted embodiment, the handle release lever 408 is hook-shaped adjacent a first end 432 and is straight adjacent a second end 434. A flat spring 436 includes an opening to receive the handle release lever 408. The flat spring 436 attaches to the second tubular member using a fastener 438. The spring 436 biases the handle release lever 408 into the respective openings 404, 406, 412, and 414 of the handle 380. More specifically, the first tubular member 384 includes an opening 442 and the corresponding sleeve bushing 428 includes an opening 444 that receives the first end 432 of the handle release lever 408 such that the first end of the handle release lever can be selectively received inside the upper opening 404 or the lower opening 406 of the handle 380. Similarly, the second tubular member 386 includes an opening 446 and the corresponding sleeve bushing 430 includes an opening 448 to selectively receive second end 434 of the handle release lever 408.

Similar to the embodiments disclosed with reference to FIGS. 1-9, the drain cleaning apparatus 310 depicted in FIGS. 10-12 also includes skid surfaces to facilitate moving the apparatus up and down a flight of stairs. In the depicted embodiment, the stair climber skids are formed by the tubular members 384 and 386 of the frame assembly. With specific reference to FIG. 12, the first tubular member 384 defines a first skid surface 450 and the second tubular member 386 defines a second skid surface 452 (shown in FIG. 10). In the depicted embodiment, the tubular members 384 and 386 are identical in configuration. Accordingly, for the sake of brevity, the first tubular member 384 and its respective skid surface 450 will be described in more detail with reference to FIG. 12.

The first tubular member 384 is a hollow cylindrical metal (or plastic) piece. When the handle 380 is in the upright position, as shown in FIG. 12, a portion of the first tubular member 384 provides the first skid surface 450. Therefore, the tubular members can also be referred to as stair climber skids, such that when the apparatus 310 is dragged or wheeled near a stair having a conventional height the corner of the stair, i.e. the intersection between the vertical and horizontal portion of the stair, contacts the skid surface 450 to provide a pivot point about which the apparatus is pivoted and then pulled along the skid surface 450.

When the handle 380 is disposed in the second (lower) position, the feet 422 and 424 engage the ground surface, similar to what is shown in FIG. 4, and the wheels 364 and 366 are set off of the ground surface H. The apparatus 310 rests on the feet 422 and 424, the foot pads 344 and 346 and a portion of the U-shaped member 338 of the frame assembly 312. When the handle is moved from the first position into the second position, the center of gravity of the apparatus 310 can shift (to the left in FIGS. 11 and 12). In other words, the center of gravity of the apparatus shifts further away from the distal end (right end in FIGS. 11 and 12) of the drum unit 314.

With reference to FIG. 10, the drum driving assembly 316 includes an electric reversible motor 460 that includes an output shaft (not visible) to which a pulley 462 mounts. The output shaft of the motor 460 extends rearwardly out of the motor housing as opposed to the opening in the drum 314 (FIG. 11) through which the cable extends, which is forwardly disposed. As most clearly seen in FIG. 11, the motor 460 is positioned above the drum 314 and between the axially spaced front and rear ends of the drum. This provides for a compact apparatus that is easier to maneuver.

The pulley 462 engages an endless belt 464 that wraps around a peripheral wall of the drum 314 to rotate the same. The motor 460 attaches to the motor mount plate 356 via fasteners 466. The motor 460 is an electric reversible motor that includes a switch 468 that can control the direction (forward and reverse) of rotation of the motor. A power cord 470 connects to the motor 460 to provide AC power to the motor. A foot bulb 472 also connects to the motor 460. The foot bulb 472 communicates with a pneumatic switch so that the operator of the apparatus 310 can step on the foot bulb 472 to selectively supply power to the electric motor 460.

A belt guard, or shroud, 474 attaches to the frame assembly 312 using fasteners 476. The belt guard 474 covers the belt 464 and the pulley 462 to provide protection to these components and also to provide a stationary piece between the operator of the apparatus 310 and the moving components of the apparatus. The belt guard 476 can also include a pocket 478 for the storage of tools and other implements that can be used with the drain cleaning apparatus. The frame assembly 312 can also include cord wrap caps 482 and 484 that attach to the distal ends 328 and 330 of the frame assembly 312. The cord wrap caps 482 and 484 provide a guide about which the power cord 470 and the hose associated with the foot bulb 472 can be wrapped.

A belt tensioning assembly is provided to tension the belt 464. If desired, a stretch belt can be used obviating the need for a belt tensioning assembly. The belt tensioning assembly includes an idler pulley arm 480 that connects to the motor mount plate 356 using a fastener 482 and washer 484. The idler pulley arm 480 includes a bend separating two parallel planar portions. A spring 486 attaches to the motor mount plate 356 and the idler pulley arm 480 to bias the idler pulley arm to provide tension to the belt 464. An idler pulley 488 attaches to the idler pulley arm 480 using a flange bearing 490, a fastener 492 and washers 494. By providing the belt tensioning assembly, the motor 460 can be fixed with respect to the frame 312.

With reference to FIGS. 10 and 11, the cable storage drum 314 mounts to the frame 312. The cable storage drum unit 314 and the accompanying components are the same as those described with reference to FIGS. 1-9; therefore, further explanation is not provided.

A drain cleaning apparatus has been described with reference to two embodiments. Alternatives of these embodiments have also been described. The invention, however, is not limited to only the embodiments and the alternatives described in the preceding description; instead, the invention is broadly defined by the appended claims and the equivalents thereof.

1. A drain cleaning apparatus comprising:
a frame member configured to rest on an associated surface;
a rotatable cable storage drum mounted to the frame member, the drum defining an axis and including axially spaced front and rear ends and a radially outer peripheral wall between the front and rear ends, the front end including an opening;
a drain cleaning cable coiled in the drum about the axis, the cable including an outer end portion extending through the opening in a first direction; and
a motor including an output shaft and a motor housing, the motor being positioned above the drum and generally between the front and rear ends of the drum, the output shaft being operatively connected to the drum for rotating the drum and extending from an opening in the motor housing in a second direction that is generally opposite the first direction.

2. The apparatus of claim 1, wherein the first direction is generally parallel to the second direction.

3. The apparatus of claim 1, further comprising a stair climber skid on the frame member.

4. The apparatus of claim 1, further comprising a belt operatively connecting the motor and the drum, and a belt tensioner mounted to the frame member for tensioning the belt.

5. The apparatus of claim 4, wherein the motor is connected to the frame member in a manner such that the motor housing does not move with respect to the frame member.

6. The apparatus of claim 4, further comprising a belt guard attached to the frame member and covering at least a portion of the belt, the belt guard including a pocket configured to store associated tools.

7. The apparatus of claim 1, wherein the frame member includes spaced first and second power cord wrapping portions configured to have an associated power cord wrapped around the first and second power cord wrapping portions.

8. The apparatus of claim 7, further comprising a first cord cap attached to the first cord wrapping portion and a second cord cap attached to the second cord wrapping portion.

9. The apparatus of claim 1, further comprising a telescoping handle connected to the frame member, the handle including a distal portion configured to selectively contact the associated surface to provide stability to the drain cleaning apparatus.

10. A drain cleaning apparatus comprising:
a frame member;
a wheel connected to the frame member;
a rotatable cable storage drum mounted to the frame member, the drum defining an axis and including axially spaced front and rear ends and a radially outer peripheral wall between the front and rear ends, the front end including an opening;
a drain cleaning cable coiled in the drum about the axis, the cable including an outer end portion extending through the opening in a first direction; and
a stair climber skid on the frame member near the wheel, the skid including a skid surface configured to slidably engage an associated stair when the apparatus is being moved up or down a staircase that includes the associated stair.

11. The apparatus of claim 10, wherein the stair climber skid comprises a molded piece and the skid surface being tapered.

12. The apparatus of claim 10, wherein the stair climber comprises a hollow tubular member.

13. The apparatus of claim 12, further comprising a movable handle connected to the frame member, wherein the stair climber skid receives the handle.

14. The apparatus of claim 13, wherein the handle is movable into a position where the distal portion contacts the associated surface.

15. The apparatus of claim 10, wherein the stair climber skid includes first and second stair climber skids each attached to the frame member at spaced locations from one another.

16. The apparatus of claim 15, wherein the first and second stair climber skids are identical in configuration.

17. A drain cleaning apparatus comprising:
a frame member including a portion configured to selectively rest on an associated surface;
a rotatable cable storage drum mounted to the frame member, the drum defining an axis and including axially spaced front and rear ends and a radially outer peripheral wall between the front and rear ends, the front end including an opening;
a drain cleaning cable coiled in the drum about the axis, the cable including an outer end portion extending through the opening; and
a movable member connected to the frame member and selectively movable between a first position and a second position, the movable member including a handle grip portion and a surface engaging portion configured to contact the associated surface when the movable member is in the second position.

18. The apparatus of claim 17, further comprising a wheel connected to the frame member.

19. The apparatus of claim 18, wherein when the movable member is in the second position, the frame member and the surface engaging portion support the apparatus such that the wheel does not contact the associated surface.

20. The apparatus of claim 17, wherein the movable member slides between the first position and the second position.

21. The apparatus of claim 17, wherein the surface engaging portion comprises first and second distal ends spaced from one another.

22. The apparatus of claim 17, further comprising a locking mechanism operatively connected to the movable member, the locking mechanism cooperating with the movable member to selectively lock the movable member in the first position and in the second position.

23. The apparatus of claim 17, further comprising a stair climber skid connected to the frame member and the movable member, the stair climber skid including at least one of a portion of a locking mechanism and a skid surface, the locking mechanism cooperating with the movable member to selectively lock the movable member in the first position and in the second position and the skid surface being configured to slide on an associated stair when the apparatus is being moved up or down a staircase that includes the associated stair.

24. The apparatus of claim 17, wherein the movable member comprises a generally U-shaped member, the surface engaging members being distal ends of the U-shaped member.
